(19) United States
(12) Patent Application Publication
(10) Pub. No.: US 2020/0074300 A1
(43) Pub. Date: Mar. 5, 2020

(54) ARTIFICIAL-INTELLIGENCE-AUGMENTED CLASSIFICATION SYSTEM AND METHOD FOR TENDER SEARCH AND ANALYSIS

(71) Applicant: Patabid Inc., Okotoks (CA)

(72) Inventor: Melvin NEWMAN, Okotoks (CA)

(21) Appl. No.: 16/537,251

(22) Filed: Aug. 9, 2019

Related U.S. Application Data
(60) Provisional application No. 62/723,774, filed on Aug. 28, 2018.

(51) Int. Cl. G06N 3/08; G06N 20/00

(52) U.S. Cl. CPC G06N 3/08; G06N 20/00

(57) ABSTRACT

A data-classification system has a data collection module for collecting raw data from a plurality of data sources, a data extraction module for extracting unclassified data from the raw data, a data classification module comprising a neural network architecture for classifying unclassified data; and an interface for, in response to a query from a user, retrieving classified data based on a profile of the user, and sending the retrieved data to the user. The neural network architecture comprises a pre-trained word-representation layer comprising a pre-trained library, and N (N>1 being a positive integer) one-dimensional convolutional (Conv1D) layers and (N−1) one-dimensional max-pooling (MaxPool1D) layers coupled in serial. Each MaxPool1D layer is intermediate two neighboring Conv1D layers. In some embodiments, the data is tender information.

### CROSS-REFERENCE TO RELATED APPLICATIONS

This application claims the benefit of U.S. Provisional Patent Application Ser. No. 62/723,774, filed Aug. 28, 2018, the content of which is incorporated herein by reference in its entirety.

### FIELD OF THE DISCLOSURE

The present disclosure relates generally to a system and method for tender search and analysis, and in particular to a system and method using artificial intelligence for tender search and analysis.

### BACKGROUND

In many industries, technical documentation is used for achieving various goals such as product design and specification, putting out tender packages for contractors to price, and the like.

A tender package is a collection of technical documents that a purchaser publishes for contractors, suppliers, consultants, and other relevant users to review and offer services. A tender package is often published in an online repository. The documents of a tender pack may range from simple descriptions of the services required (such as computer repairs for a municipal office) to detailed design packages for the construction of large infrastructure projects (such as roads, highways, bridges, and the like) and buildings.

One of the major tasks for companies providing services is to find tenders and pre-analyze identified tenders to filter out those presenting the best business opportunities. However, such tasks are often challenging due to the large quantities of information, limited timelines, and fractured distribution network. For example, searching for tenders and bidding opportunities is time consuming, and it may often miss tenders that are published in dispersed locations.

Prior-art systems such as MERX® and Biddingo (MERX is a registered trademark of Mediagrif Interactive Technologies Inc., Longueuil, QC, CA) usually use keyword searching for finding tenders and typically using Global Shipment Identification Numbers (GSINs) for classifying tender packages. Such keyword searching generally involves the manual generation and maintenance of keyword search lists. However, such methods are prone to errors (for example, if a keyword is missed, not mentioned, or typed incorrectly in a tender listing) and may not provide results with sufficient relevance to users' needs.

Moreover, tender posters may often make mistakes in their posting. Such mistakes may be simple mistakes such as spelling errors, or may be complex mistakes such as posting the tender packages in hard-to-find locations, posting the tender packages in locations unsuitable for the publishing such tender packages, posting the tender packages in locations mismatching the content of the tender packages, and/or the like. For example, a tender author may inadvertently post a tender for the procurement of construction services for a hospital under a healthcare equipment procurement category, and then the target audience would most likely miss the tender. Such mistakes may make the analysis of tender packages difficult.

Therefore, there exists a need for a powerful tool to collect tender packages and analyze identified technical documents distributed in tender packages.

### SUMMARY

Embodiments herein discloses a classification system for processing and classifying data using artificial intelligence (AI) such as neural networks. In some embodiments, the AI used in the classification system solves an important problem of analyzing significant amounts of technical documentation related to a plurality of fields and classifying the data thereof into one of a plurality of categories defined by the trainer of the AI.

According to one aspect of this disclosure, the classification system disclosed herein uses automated search application programming interfaces (APIs) for collecting relevant information such as tender information from a plurality of locations and sources. The classification system categories the collected information into locations, regions, and the like, and utilizes a neural-network artificial intelligence to classify the collected information by sectors, products, requirements, and the like. The classification system pre-screens tenders with the artificial intelligence to capture key risk items such as delivery dates, schedule milestones, locations, and the like, and stores all information in a centralized knowledge repository such as a database using Structured Query Language (SQL).

The users of the classification system are thus alleviated from searching for tenders as the classification system automatically collects and classifies tender information and presents the users with relevant results.

In some embodiments, the classification system disclosed herein may collect and process about 200 tenders per day. Such a workload represents a large amount of information for processing which may be labor-intensive for a human to manually work therethrough.

In some embodiments, the classification system disclosed herein uses a multi-layer neural network architecture for analyzing and classifying collected tender information. In some embodiments, the neural network architecture used in the classification system is specially tuned for natural language processing and is designed to understand the technical language used in tender packages.

By using the multi-layer neural network architecture, the classification system collects and categorizes tender packages based on their content regardless of how, where, or in what format the tender packages are posted by the tender authors.

By using the classification system disclosed herein, users may simply select their geographic region of interest along with the industries they operate therein. In response, the classification system presents users with the results they are interested in, thereby ensuring timely, accurate, and relevant results readily for users to use.

In some embodiments, the classification system disclosed herein may also analyze tender packages based on other categories such as due dates, documentation requirements, key product requirements, and the like for further assisting users in bidding for the tenders.

In some embodiments, the classification system disclosed herein may use a dynamic database to facilitate continuous expansion and acceleration of the AI processes.

In some embodiments, the classification system disclosed herein may use a dataset for training the neural networks.

In some embodiments, the classification system disclosed herein may be used for searching for tender opportunities with accurate and timely tender search results.

In some embodiments, the classification system disclosed herein may be used in the construction industry.

In some embodiments, the classification system disclosed herein may be used in the services and procurement industries.

In some embodiments, the classification system disclosed herein may be used in the shipping and/or transportation industries.

According to one aspect of this disclosure, the classification system disclosed herein solves a technical problem of developing a computerized methodology of retrieving, storing and encoding information for a neural network to analyze and categorize the information into a plurality of categories.

According to one aspect of this disclosure, the classification system disclosed herein automates the tender search and discovery portions of business.

In some embodiments, the classification system collects sufficient data such that a neural network may be trained to segregate desired information out of the multitude of extraneous items that are published. For this purpose, the classification system comprises an automated information collection module.

In some embodiments, the automated information collection module is based on web scraping technology that collects information from tender publication sites. In some embodiments, the automated information collection module comprises an information collector for collecting information from emails and other distributed data sources.

The information from the web scraper and/or information collector is then fed into a first stage that uses rules to categorize various aspects of the collected tenders such as region of delivery, owner, tender organization, and the like. This information is then fed through a pipeline to a data storage engine which comprises a collection of tables in a relational database that stores the information.

After storing the information, the AI is used to extract inferences from the stored information. In some embodiments, the AI is built on neural networks and the information is encoded in a manner compatible with the neural network. In some embodiments, methods such as tokenizing, one-hot encoding, and the like, may be used for information encoding.

For example, in some embodiments, a tokenizing technique may be used to utilize a tokenizer to numerically encode the information. In particular, a mapping is built in memory to link each word in the text of the information to be encoded to a numerical value, thereby allowing all texts to be converted into a vector with each word represented by a numerical value.

The categories are also encoded for facilitating the categorization of technical documents using AI. In some embodiments, a one-hot encoding scheme may be used to encode the categories in an automated fashion, thereby allowing categories to be modified and added as required.

The encoded information is processed by a trained neural network for mathematically categorizing the encoded information. The output of the trained neural network is processed by a decoding layer for converting the numeric output of the trained neural network back into the categorical format.

In some embodiments, the classification system continuously retrains the AI such as the neural networks. After a dataset is processed by the neural networks, the results thereof are crosschecked and verified for accuracy. Necessary corrections are applied in the data storage facility. Then, the entire knowledge base is used to retrain the neural networks thereby allowing for a rapid increase in accuracy.

All collected data is classified and stored in the data storage engine. The classified data is then summarized and presented in a human-readable and actionable format using a web-based front-end.

According to one aspect of this disclosure, there is provided a computerized data-classification system. The data-classification system comprises: a memory; one or more processing structures coupled to the memory and comprising: a data collection module for collecting raw data from a plurality of data sources; a data extraction module for extracting unclassified data from the raw data; a data classification module comprising a neural network architecture for classifying unclassified data into classified data; and an interface for, in response to a query from a user, retrieving classified data based on a profile of the user, and sending the retrieved data to the user. The neural network architecture comprises: a pre-trained word-representation layer comprising a pre-trained library; and N one-dimensional convolutional (Conv1D) layers and (N−1) one-dimensional max-pooling (MaxPool1D) layers coupled in serial with each MaxPool1D layer intermediate two neighboring Conv1D layers, where N>1 is a positive integer.

In some embodiments, said data classification module is configured for adaptively adjusting N between 2 and 3.

In some embodiments, the system further comprises one or more databases for storing at one of the collected raw data, the extracted unclassified data, the classified data, the profile of the user, and the pre-trained library.

In some embodiments, said data extraction module is further configured for cleaning and sanitizing the extracted unclassified data by removing predefined data items.

In some embodiments, said data extraction module is configured for extracting unclassified data based on a predefined set of rules.

In some embodiments, said data extraction module is further configured for collecting geospatial data using a map function.

In some embodiments, said data classified data comprises a plurality of data categories; and said data classification module is configured for: encoding the unclassified data into a numerical representation for the neural network architecture to process; processing the encoded data by the neural network architecture, the neural network architecture mathematically categorizing the encoded data and outputting a numeric output; and decoding the numeric output into a categorical format.

In some embodiments, said encoding the unclassified data comprises using a tokenizer to numerically encode the unclassified data by using a mapping between text words and corresponding numerical values.

In some embodiments, the neural network architecture further comprises a one-dimensional global max pooling (GlobalMax1D) layer after a last one of the Conv1D layers.

In some embodiments, the neural network architecture further comprises a network layer after the GlobalMax1D layer, said network layer comprising a plurality of neurons; and a total number of the plurality of neurons equals to a total number of the data categories.

In some embodiments, said network layer is configured for using a softmax activation function to generate the numeric output of the neural network architecture.

In some embodiments, said plurality of data sources comprise at least a plurality of web servers.

In some embodiments, said one or more processing structures further comprise a trainer module for training the neural network architecture of the data classification module.

In some embodiments, said trainer module is configured for repeatedly called for continuously training the neural network architecture of the data classification module.

According to one aspect of this disclosure, there is provided a method for assessing user performance. The method comprises: collecting raw data from a plurality of data sources; extracting unclassified data from the raw data; classifying unclassified data into classified data by using a neural network architecture; and in response to a query from a user, retrieving classified data based on a profile of the user, and sending the retrieved data to the user. The neural network architecture comprises: a pre-trained word-representation layer comprising a pre-trained library; and N one-dimensional convolutional (Conv1D) layers and (N−1) one-dimensional max-pooling (MaxPool1D) layers coupled in serial with each MaxPool1D layer intermediate two neighboring Conv1D layers, where N>1 is a positive integer.

In some embodiments, N is 2 or 3.

In some embodiments, the method further comprises adaptively adjusting N between 2 and 3.

In some embodiments, the method further comprises storing in one or more databases at one of the collected raw data, the extracted unclassified data, the classified data, the profile of the user, and the pre-trained library.

In some embodiments, the method further comprises cleaning and sanitizing the extracted unclassified data by removing predefined data items.

In some embodiments, said extracting the unclassified data from the raw data comprises extracting the unclassified data from the raw data based on a predefined set of rules.

In some embodiments, the method further comprises collecting geospatial data using a map function.

In some embodiments, said data classified data comprises a plurality of data categories; and the method further comprises: encoding the unclassified data into a numerical representation for the neural network architecture to process; processing the encoded data by the neural network architecture, the neural network architecture mathematically categorizing the encoded data and outputting a numeric output; and decoding the numeric output into a categorical format.

In some embodiments, said encoding the unclassified data comprises using a tokenizer to numerically encode the unclassified data by using a mapping between text words and corresponding numerical values.

In some embodiments, the neural network architecture further comprises a one-dimensional global max pooling (GlobalMax1D) layer after a last one of the Conv1D layers.

In some embodiments, the neural network architecture further comprises a network layer after the GlobalMax1D layer, said network layer comprising a plurality of neurons; and a total number of the plurality of neurons equals to a total number of the data categories.

In some embodiments, said network layer is configured for using a softmax activation function to generate the numeric output of the neural network architecture.

In some embodiments, said collecting the raw data from the plurality of data sources comprises collecting the raw data from at least a plurality of web servers.

In some embodiments, the method further comprises training the neural network architecture of the data classification module.

In some embodiments, said training the neural network architecture of the data classification module comprises repeatedly training the neural network architecture of the data classification module.

According to one aspect of this disclosure, there is provided a computer-readable storage device comprising computer-executable instructions for assessing user performance, wherein the instructions, when executed, cause a processing structure to perform actions comprising: collecting raw data from a plurality of data sources; extracting unclassified data from the raw data; classifying unclassified data into classified data by using a neural network architecture; and in response to a query from a user, retrieving classified data based on a profile of the user, and sending the retrieved data to the user. The neural network architecture comprises: a pre-trained word-representation layer comprising a pre-trained library; and N one-dimensional convolutional (Conv1D) layers and (N−1) one-dimensional max-pooling (MaxPool1D) layers coupled in serial with each MaxPool1D layer intermediate two neighboring Conv1D layers, where N>1 is a positive integer.

In some embodiments, N is 2 or 3.

In some embodiments, the instructions, when executed, cause a processing structure to perform further actions comprising adaptively adjusting N between 2 and 3.

In some embodiments, the instructions, when executed, cause a processing structure to perform further actions comprising storing in one or more databases at one of the collected raw data, the extracted unclassified data, the classified data, the profile of the user, and the pre-trained library.

In some embodiments, the instructions, when executed, cause a processing structure to perform further actions comprising cleaning and sanitizing the extracted unclassified data by removing predefined data items.

In some embodiments, said extracting the unclassified data from the raw data comprises extracting the unclassified data from the raw data based on a predefined set of rules.

In some embodiments, the instructions, when executed, cause a processing structure to perform further actions comprising collecting geospatial data using a map function.

In some embodiments, said data classified data comprises a plurality of data categories; and the instructions, when executed, cause a processing structure to perform further actions comprising: encoding the unclassified data into a numerical representation for the neural network architecture to process; processing the encoded data by the neural network architecture, the neural network architecture mathematically categorizing the encoded data and outputting a numeric output; and decoding the numeric output into a categorical format.

In some embodiments, said encoding the unclassified data comprises using a tokenizer to numerically encode the unclassified data by using a mapping between text words and corresponding numerical values.

In some embodiments, the neural network architecture further comprises a one-dimensional global max pooling (GlobalMax1D) layer after a last one of the Conv1D layers.

In some embodiments, the neural network architecture further comprises a network layer after the GlobalMax1D layer, said network layer comprising a plurality of neurons; and a total number of the plurality of neurons equals to a total number of the data categories.

In some embodiments, said network layer is configured for using a softmax activation function to generate the numeric output of the neural network architecture.

In some embodiments, said collecting the raw data from the plurality of data sources comprises collecting the raw data from at least a plurality of web servers.

In some embodiments, the instructions, when executed, cause a processing structure to perform further actions comprising training the neural network architecture of the data classification module.

In some embodiments, said training the neural network architecture of the data classification module comprises repeatedly training the neural network architecture of the data classification module.

### BRIEF DESCRIPTION OF THE DRAWINGS

FIG. 1 illustrates a classification system, according to some embodiments of this disclosure;

FIG. 2 shows an exemplary hardware structure of the computing devices of the classification system shown in FIG. 1;

FIG. 3 shows a simplified software architecture of the computing devices of the classification system shown in FIG. 1;

FIG. 4 shows a software structure of the classification system shown in FIG. 1, according to some embodiments of this disclosure;

FIG. 5 shows the functionalities of the classification system shown in FIG. 1;

FIG. 6 is a flowchart showing the detail of the data collection functionality shown in FIG. 5;

FIG. 7 is a flowchart showing the detail of the AI training functionality shown in FIG. 5;

FIG. 8 show a multiple-layer neural network architecture of the data classification module shown in FIG. 5;

FIG. 9 show an example of the multiple-layer neural network architecture shown in FIG. 8;

FIG. 10 is a flowchart showing the detail of the AI-based data classification functionality shown in FIG. 5;

FIG. 11 is a flowchart showing the detail of the data query functionality shown in FIG. 5;

FIG. 12 is a screenshot showing dashboard view with latest relevant data;

FIGS. 12A and 12B show enlarged portions of the dashboard view shown in FIG. 12;

FIG. 13 is a screenshot showing general text and radius-based search page options; and

FIG. 14 is a screenshot showing a profile-settings page that allows selection of relevant categories and locations.

### DETAILED DESCRIPTION

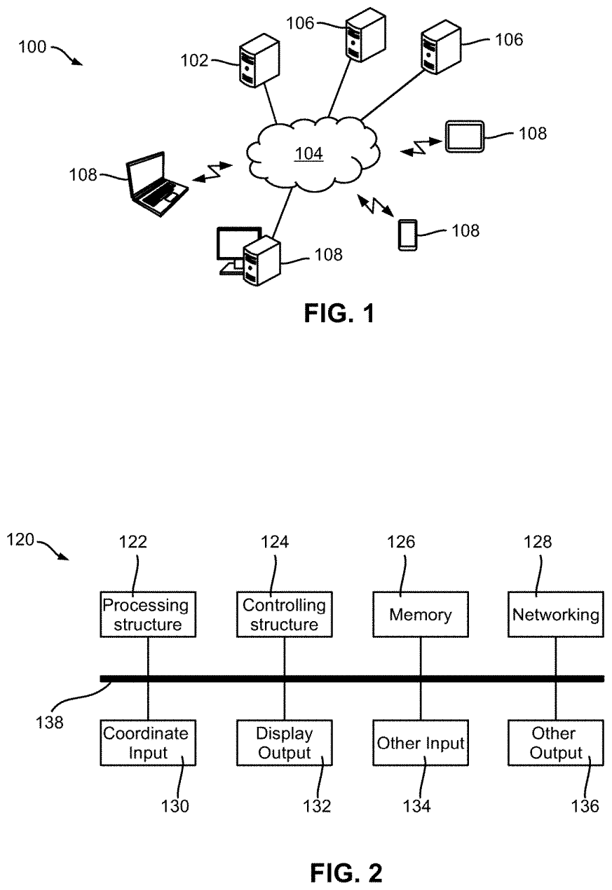

Turning now to FIG. 1, a classification system is shown and is generally identified using reference numeral 100. In these embodiments, the classification system 100 reads and classifies technical documentation written in one or more languages.

In these embodiments, the classification system 100 is a network system comprising one or more classification server computers 102 connecting to a network 104 such as the Internet, a local area network (LAN), a wide area network (WAN), a metropolitan area network (MAN), and/or the like, via suitable wired or wireless communication means such as Ethernet, WI-FI®, (WI-FI is a registered trademark of Wi-Fi Alliance, Austin, Tex., USA), BLUETOOTH® (BLUETOOTH is a registered trademark of Bluetooth Sig Inc., Kirkland, Wash., USA), ZIGBEE® (ZIGBEE is a registered trademark of ZigBee Alliance Corp., San Ramon, Calif., USA), 3G, 4G, and/or 5G wireless mobile telecommunications technologies, and/or the like.

Generally, the network 104 is connected to one or more external computing devices 106 such as one or more external servers publishing information in a field that the classification server computers 102 are interested in, for example, one or more external web servers 106 running web services for publishing information of tenders that the users of the classification system 100 may participate. The information published by the external servers 106 may be in a text form with images, audio/video clips, and/or the like.

A plurality of client computing-devices 108 such as desktop computers, laptop computers, tablets, smartphones, Personal Digital Assistants (PDAs) and the like, are also connected to the network 104 via suitable wired or wireless means for accessing the classification server 102 to obtain classified tender information.

Depending on implementation, the server computer 102 may be a server computing-device, and/or a general-purpose computing device acting as a server computer while also being used by a user. Generally, the computing devices 102 and 108 have a similar hardware structure.

FIG. 2 shows an exemplary hardware structure 120 of the computing devices 102 and 108. As shown, the computing device 102/108 comprises a variety of circuitries for performing computational and logical functionalities, and may be organized, categorized or otherwise manufactured in a variety of hardware components in the forms of integrated circuitries (ICs), printed circuit boards (PCBs), individual electrical and/or optical components, and/or the like. For example, in these embodiments, the circuitries of the computing device 102/108 include a processing structure 122, a controlling structure 124, memory or storage 126, a networking interface 128, a coordinate input 130, a display output 132, and other input and output modules 134 and 136, all interconnected by a system bus 138.

The processing structure 122 may be one or more single-core or multiple-core computing processors such as INTEL® microprocessors (INTEL is a registered trademark of Intel Corp., Santa Clara, Calif., USA), AMD® microprocessors (AMD is a registered trademark of Advanced Micro Devices Inc., Sunnyvale, Calif., USA), ARM® microprocessors (ARM is a registered trademark of Arm Ltd., Cambridge, UK) manufactured by a variety of manufactures such as Qualcomm of San Diego, Calif., USA, under the ARM® architecture, or the like.

The controlling structure 124 comprises a plurality of controllers or in other words, controlling circuitries, such as graphic controllers, input/output chipsets and the like, for coordinating operations of various hardware components and modules of the computing device 102/108.

The memory 126 comprises a plurality of memory units accessible by the processing structure 122 and the controlling structure 124 for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like. In use, the memory 126 is generally divided to a plurality of portions for different use purposes. For example, a portion of the memory 126 (denoted as storage memory herein) may be used for long-term data storing, for example, storing files or databases. Another portion of the memory 126 may be used as the system memory for storing data during processing (denoted as working memory herein).

The networking interface 128 comprises one or more networking modules for connecting to other computing devices or networks through the network 104 by using suitable wired or wireless communication technologies such as those described above. In some embodiments, parallel ports, serial ports, USB connections, optical connections, or the like may also be used for connecting other computing devices or networks although they are usually considered as input/output interfaces for connecting input/output devices.

The display output 132 comprises one or more display modules for displaying images, such as monitors, LCD displays, LED displays, projectors, and the like. The display output 132 may be a physically integrated part of the computing device 102/108 (for example, the display of a laptop computer or tablet), or may be a display device physically separated from, but functionally coupled to, other components of the computing device 102/108 (for example, the monitor of a desktop computer).

The coordinate input 130 comprises one or more input modules for one or more users to input coordinate data, such as touch-sensitive screen, touch-sensitive whiteboard, trackball, computer mouse, touch-pad, other human interface devices (HID), and/or the like. The coordinate input 130 may be a physically integrated part of the computing device 102/108 (for example, the touch-pad of a laptop computer or the touch-sensitive screen of a tablet), or may be a display device physically separated from, but functionally coupled to, other components of the computing device 102/108 (for example, a computer mouse). The coordinate input 130 in some implementation may be integrated with the display output 132 to form a touch-sensitive screen or touch-sensitive whiteboard.

The computing device 102/108 may also comprise other input 134 such as keyboards, microphones, scanners, cameras, positioning components such as a Global Positioning System (GPS) component, and/or the like. The computing device 102/108 may further comprise other output 136 such as speakers, printers, and/or the like.

The system bus 138 interconnects various components 122 to 136 enabling them to transmit and receive data and control signals to/from each other.

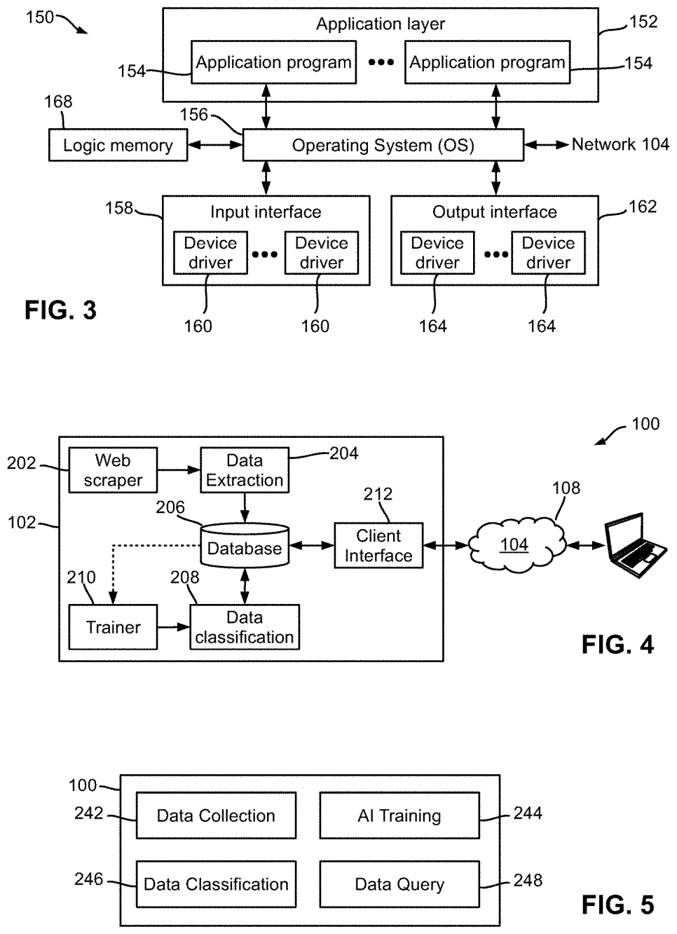

FIG. 3 shows a simplified software architecture 150 of a computing device 102/108. The software architecture 150 comprises an application layer 152 having one or more application programs or program modules 154 executed or run by the processing structure 122 for performing various jobs, an operating system 156, an input interface 158, an output interface 162, and logic memory 168.

The operating system 156 manages various hardware components of the computing device 102/108 via the input interface 158 and the output interface 162, manages logic memory 168, and manages and supports the application programs 154. The operating system 156 is also in communication with other computing devices (not shown) via the network 104 to allow application programs 154 to communicate with application programs running on other computing devices.

As those skilled in the art appreciate, the operating system 156 may be any suitable operating system such as MICROSOFT® WINDOWS® (MCROSOFT and WINDOWS are registered trademarks of the Microsoft Corp., Redmond, Wash., USA), APPLE® OS X, APPLE® iOS (APPLE is a registered trademark of Apple Inc., Cupertino, Calif., USA), Linux, ANDROID® (ANDRIOD is a registered trademark of Google Inc., Mountain View, Calif., USA), or the like. The computing devices 102/108 of the classification system 100 may all have the same operating system, or may have different operating systems.

The input interface 158 comprises one or more input device drivers 160 for communicating with respective input devices including the coordinate input 130 and other input 134. Input data received from the input devices via the input interface 158 is sent to the application layer 152 and is processed by one or more application programs 154 thereof. The output interface 162 comprises one or more output device drivers 164 managed by the operating system 156 for communicating with respective output devices including the display output 132 and other output 136. The output generated by the application programs 154 is sent to respective output devices via the output interface 162.

The logical memory 168 is a logical mapping of the physical memory 126 for facilitating the application programs 154 to access. In this embodiment, the logical memory 168 comprises a storage memory area that is usually mapped to non-volatile physical memory, such as hard disks, solid-state disks, flash drives and the like, for generally long-term storing data therein. The logical memory 168 also comprises a working memory area that is generally mapped to high-speed, and in some implementations volatile, physical memory such as RAM, for application programs 154 to generally temporarily store data during program execution. For example, an application program 154 may load data from the storage memory area into the working memory area, and may store data generated during its execution into the working memory area. The application program 154 may also store some data into the storage memory area as required or in response to a user's command.

In a server computer 102, the application layer 152 generally comprises one or more server application programs 154, which provide server-side functions for managing network communications with the external servers 106 and the client computing-devices 108, collecting tender information, classifying the collected tender information, and providing the classified tender information to the client computing-devices 108 for users to review.

In a client computing-device 108, the application layer 152 generally comprises one or more client application programs 154, which provide client-side functions for communicating with the server application programs 154, displaying information and data on the GUI thereof, receiving user's instructions, sending requests such as queries of tender information to the server computer 102, receiving requested data such as query results from the server computer 102, accessing the external servers 106 described in the query results for bidding, and the like.

FIG. 4 shows a software structure of the classification system 100 according to some embodiments of this disclosure. In these embodiments, various functional modules of the classification system 100 are implemented as a plurality of modules in an application program 154. Of course, those skilled in the art will appreciate that, in some alternative embodiments, the functional modules of the classification system 100 may alternatively be implemented as a plurality of application programs 154. In some other embodiments, the functional modules of the classification system 100 may be implemented as system services in the operating system 156 or as a firmware.

In these embodiments, the classification server computer 102 comprises a web scrapper or web crawler 202 for “crawling” through a plurality of external servers 106 such as a plurality of external web servers to collect tender information published thereon. As those skilled in the art will appreciate, the web scraper 202 may be implemented in any suitable technology. For example, in some embodiments, the web scrapper 202 is implemented using Scrapy, an open source web-crawling framework offered by Scrapinghub, Ltd. of Cork, Ireland.

The tender information collected by the web crawler 202 is sent to a data extraction module 204 for extracting relevant data which is then structured and stored in a database 206. In these embodiments, the database 206 is in a classification server computer 102. However, those skilled in the art will appreciate that, in some alternative embodiments, the database 206 may be an independent database with necessary networking functionalities for connecting to the classification server computer 102.

The classification server computer 102 comprises a data classification module 208 for classifying the tender information stored in the database 206 using artificial intelligence (AI) and storing the classified tender information back to the database 206. A trainer module 210 is used for training the data classification module 208. The classification server computer 102 also comprises a client interface 212 for interacting with client computing-devices 108 to allow users to query tender information as they are interested.

As shown in FIG. 5, the classification system 100 generally implements four functionalities, namely, data collection 242, AI training 244, data classification 246, and data query 248, which may be executed in parallel.

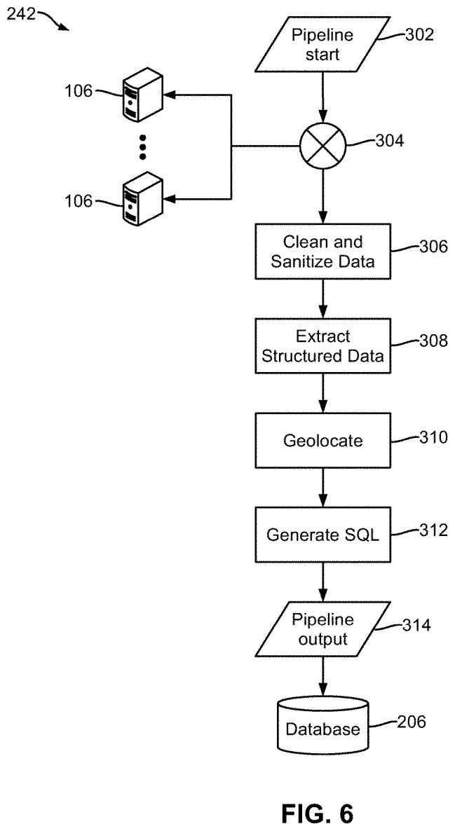

FIG. 6 is a flowchart showing the detail of the data collection functionality 242. In these embodiments, the classification system 100 collects raw data from an information repository such as a plurality of external servers 106 and uses a data-extraction pipeline to extract structured data from the collected raw data. The external servers 106 may be distributed in a wide range of locations such as towns, cities, and other municipalities, and may be owned and/or operated by a variety of entities such as schools, universities, hospitals, various levels of governments, and/or other institutions. The collectable information or data on the external servers 106 is generally a large amount of publicly available data and documentation in a field such as tender information.

As shown in FIG. 6, at step 302, a data-extraction pipeline is started for extracting structured data from raw data collected from the information repository.

At step 304, the web scraper 202 crawls through or accesses the external servers 106 to collect information and documentation published thereon. As described above, the web scrapper 202 in these embodiments is implemented using the open-source Scrapy framework. Profiles are built on this framework that collect the technical information on each tender from the external web servers 106.

When the web scraper 202 accesses an external web server 106, the web scraper 202 specifically identifies individual “tenders” based on a predefined rule set. When a webpage with tender information is identified, the web scraper 202 collects data from the identified webpage and creates an item comprising a plurality of fields as a virtual representation of the collected information such as the tender information. The web scraper 202 then passes the created item into the data-extraction pipeline for processing and storage.

At step 306, the data extraction module 204 first cleans and sanitizes the received items by removing unnecessary data pieces such as HTML tags, special characters, and the like, from the collected raw data. At step 308, the data extraction module 204 then extracts initial information from the sanitized data based on a predefined ruleset (i.e., a set of predefined rules). This step may also be considered as a preliminary rule-based categorization. In one embodiment, step 308 is implemented using a suitable programming language such as Python and utilizing basic rules to extract preliminary information from scraped tenders.

In these embodiments, the classification system 100 collects technical information on each tender from the external web servers 106. Such technical information is typically of a structured nature and consistently formatted. Therefore, once the data structure is known, the data-extraction pipeline may utilize the data structure to break down the details of the collected technical information to extract key data points such as the posting organization, project location, description, and the like for storage and preliminary rule-based analysis.

After data extraction, the data-extraction pipeline collects the geospatial data for each project by utilizing a suitable map function such as the Google maps application programming interface (API) offered by Google Inc. of Mountain View, Calif., USA, and adds this information to each item (step 310).

At step 312, the data extraction module 204 formats each item for storage in the database 206 and generates necessary Structured Query Language (SQL) commands. At step 314, the data extraction module 204 generates pipeline output (e.g., the formatted items) and uses the generated SQL commands to store the pipeline output into the database 206 for storage.

In these embodiments, storage of the tender data is implemented using a database 206 suitable for defining the inter-connectedness of the tender process. Such a database 206 may be a relational database 206 with SQL. The database 206 is defined as a normalized set of tables, and thus in practice there is a separate table for each of the key pieces of information to be stored, thereby allowing great flexibility in the use of the data when it is assembled into AI training sets and on generating data analytics.

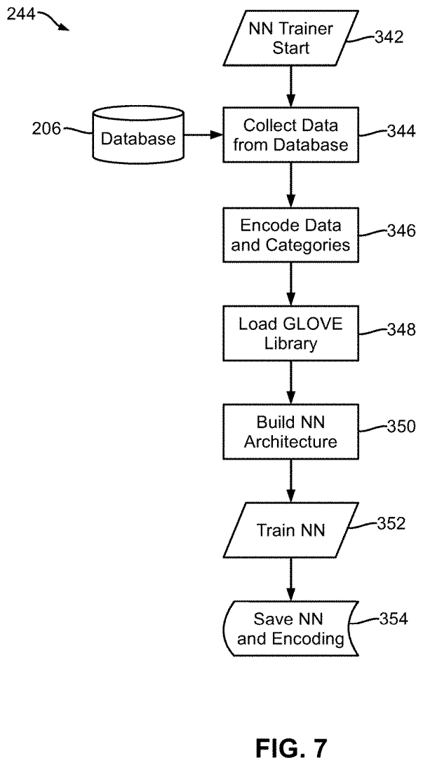

FIG. 7 is a flowchart showing the detail of the AI training functionality 244 that the trainer module 210 uses for training the data classification module 208 (see FIG. 4). In these embodiments, the data classification module 208 uses neural networks (NN) for AI-augmented data classification.

The trainer module 210 uses data stored in the database 206 for training the data classification module 208. The data in the database 206 is normalized meaning that each “piece” of information is stored in a number of separate tables in the database 206. Such data is assembled and collected in a format that the classification module 208 can operate thereon.

As shown in FIG. 7, after the NN trainer module 210 starts (step 342), the NN trainer module 210 queries the database 206 using SQL language to collect and format a set of training data (step 344). The set of data obtained at step 344 comprises the technical details for each tender in a textual format. Key items such as the purchasing organization, technical description, location, and the like, are appended together to form one corpus or text.

Once the training text is retrieved from the database 206, the retrieved training text is encoded into a format suitable for the neural networks to process (step 346). As is known in the art, neural networks may only process floating-point numbers. Therefore, at this step, the retrieved training text is encoded into a numerical representation.

In these embodiments, a tokenizing technique is used to utilize a tokenizer to numerically encode the retrieved training text. In particular, a mapping is built in memory to link each word in the text to a numerical value, thereby allowing all texts to be converted into a vector with each word represented by a numerical value.

At step 346, the categories associated with each training set are also encoded for facilitating the categorization of technical documents using AI. In these embodiments, a one-hot encoding scheme is used to encode the categories in an automated fashion, thereby allowing categories to be modified and added as required.

The AI training is then performed after the entire training data set and categories have been converted to vectors.

As described above, the data classification module 208 uses neural networks for data classification. As is known in the art, a neural network is a collection of relatively simple mathematical functions that are executed in a massively parallel and repetitive form. The neural network is trained using pre-configured training data. After training, the neural network is able to make inferences on new tender data.

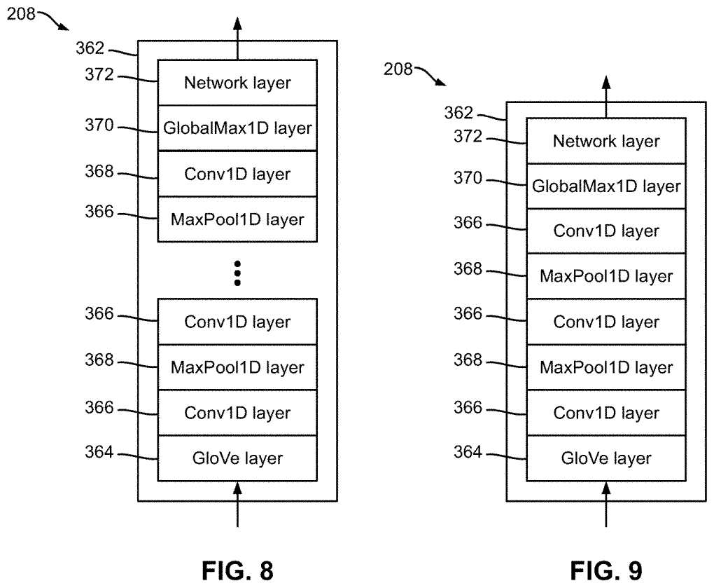

In these embodiments, the data classification module 208 uses a multiple-layer neural network architecture. As shown in FIG. 8, the multiple-layer neural network architecture 362 comprises a pre-trained GloVe (Global Vectors for Word Representation) layer 364 using the GloVe model developed by Jeffry Pennington, Richard Socher, and Christopher Manning of Stanford University. The GloVe layer 364 is a pre-trained layer comprising a pre-trained library of English words in which every word is represented in a vector that defines how close it would be to another word in the English language. Such a library is pre-trained using the entire English content of Wikipedia encyclopedia, and may be used to rapidly accelerate a NN's understanding of the English language. Of course, those skilled in the art will appreciate that, instead of use the GloVe layer, other suitable, pre-trained layer for one or more languages (e.g., English, French, Spanish, Chinese, and/or the like) may be used in some alternative embodiments.

At the output side of the pre-trained GloVe layer 364, the multiple-layer neural network architecture 362 comprises N (N>1 being a positive integer) one-dimensional convolutional (Conv1D) layers 366 and (N−1) one-dimensional max-pooling (MaxPool1D) layers 368 coupled in series with each MaxPool1D layer 368 intermediate two neighboring Conv1D layers 366. Each MaxPool1D layer 368 uses the maximum value from each of a cluster of neurons at the prior layer and has a predefined pool size.

The output of the last Conv1D layer 366 is fed into a one-dimensional global max pooling (GlobalMax1D) layer 370 which is similar to the MaxPool1D layer 368 but with a pool size substantively equal to the size of the input. The output of the GlobalMax1D layer is fed into a simple densely connected network layer 372 with the number of neurons set to the number of categories in the training set. The densely connected network layer 372 uses the softmax activation function to generate the final output of the neural network architecture of the data classification module 208.

In one example as shown in FIG. 9, the multiple-layer neural network architecture 362 comprises three Conv1D layers 366 separated by two MaxPool1D layers 368. The three Conv1D layers 366 are identical and are specified to find 1850 features in the text with a kernel size of 12. The MaxPool1D layers 368 are identical and each has a pool size of five (5).

In above example, the multiple-layer neural network architecture 362 comprises three convolutional layers 366 (i.e., N=3). In an alternative embodiment, the multiple-layer neural network architecture 362 may only comprise two Conv1D layers 366 (i.e., N=2) separated by one MaxPool1D layer 368.

Those skilled in the art will appreciate that the number N of convolutional layers 366 may be any number greater than one and the performance of the multiple-layer neural network architecture 362 may improve when the increase of N. However, increasing N may also lead to the increase of computational complexity. Generally, the performance improvement of the multiple-layer neural network architecture 362 may be marginal when N>3. Therefore, it may be preferable to set N=2 or 3 for avoiding significantly increased computational complexity while maintaining the performance of the multiple-layer neural network architecture 362 at a reasonably high level.

In some embodiments, the multiple-layer neural network architecture 362 may monitor the performance and automatically and adaptively adjusting the number N of convolutional layers 366 between 2 and 3.

In some embodiments where the system 100 may have sufficient computational power, the multiple-layer neural network architecture 362 may monitor the performance and automatically and adaptively adjusting the number N of convolutional layers 366 between 2 and a maximum number Nₘₐₓ>3.

Referring again to FIG. 7, at step 348, the GloVe library is loaded. Then, the neural network architecture described in FIG. 8 or 9 is built (step 350) and the neural network is trained using the tender information stored in the database 206 (step 352).

In particular, the pre-trained GloVe layer 364 parses the tender information retrieved from the database 206 and outputs the parsed tender information to the series of Conv1D layers 366 and MaxPool1D layers 368 for processing.

The output of the last Conv1D layer 366 is fed into a one-dimensional global max pooling (GlobalMax1D) layer 370 which is similar to the MaxPool1D layer 368 but with a pool size substantively equal to the size of the input. The output of the GlobalMax1D layer is fed into a simple densely connected network layer 372 with the number of neurons set to the number of categories in the training set. The densely connected network layer 372 uses the softmax activation function to generate the final output of the neural network architecture of the data classification module 208.

The final output of the neural network architecture of the data classification module 208 is a vector of the same size as the number of categories, with output vector values representing the probability of the input tender information fitting in any one of the categories. The highest value is selected as the category for the input information. The output vector is decoded into the matching categories (in text format) in the database using the reverse of the mapping generated in the encoding phase (step 354).

The decoded selection generated by the neural network is then stored back to the relational database 206.

In these embodiments, once training is completed, the neural network trainer 210 stores the neural network architecture on the a suitable file system such as a NTFS or Ext4 file system in a Hierarchical Data Format (HDF) file such as a H5 formatted file, or a file in other format suitable for storing and organizing large amounts of data. Along with the topology, the tokenized word map and category mappings are also saved from memory to the file system.

Once an initial training of the neural network architecture of the data classification module 208 is completed, the data classification module 208 may be used to classify the tender information collected by the web scraper 202. Meanwhile, the training of the neural network architecture of the data classification module 208 is continued for improving the performance of the data classification module 208.

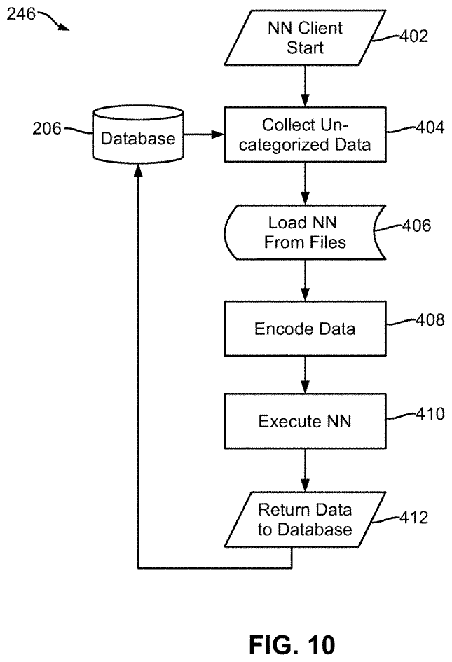

FIG. 10 is a flowchart showing the detail of the AI-based data classification functionality 246 that the data classification module 208 is used for classifying the collected tender information. As shown, after the neural network of the data classification module 208 is started (step 402), the data classification module 208 retrieves uncategorized tender data from the database 206 (step 404). The trained neural network is then executed on the uncategorized tender data.

In particular, the data classification module 208 loads the trained neural network architecture from the storage, loads tokenized word map and category mappings from the file system (step 406), and then encodes uncategorized tender data to the numeric format as described above (step 408). Then, the encoded tender data is fed into the trained neural network or classification (step 410) and the results of the neural-network categorization are stored back to the database 206 (step 412).

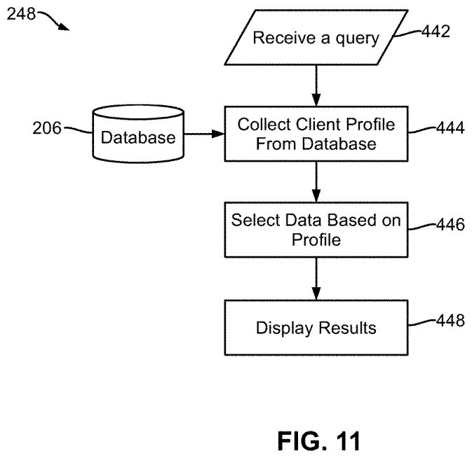

FIG. 11 is a flowchart showing the detail of the data query functionality 248 that the client interface module 212 is used for receiving and responding to client queries.

In these embodiments, the client interface module 212 is based on the Web 2.0 standards. Each client creates a profile in the relational database 206 for selecting and storing the specific categories they are interested in along with geographic location information. As shown in FIG. 11, when a query is received (step 442), the client interface module 212 loads the client profile from the database 206 (step 444) and selects categorized data based on the client profile (step 446), which is the categorized information that the user is interested in. At step 448, the selected categorized data is sent to the client computing-device 108 and is displayed thereon.

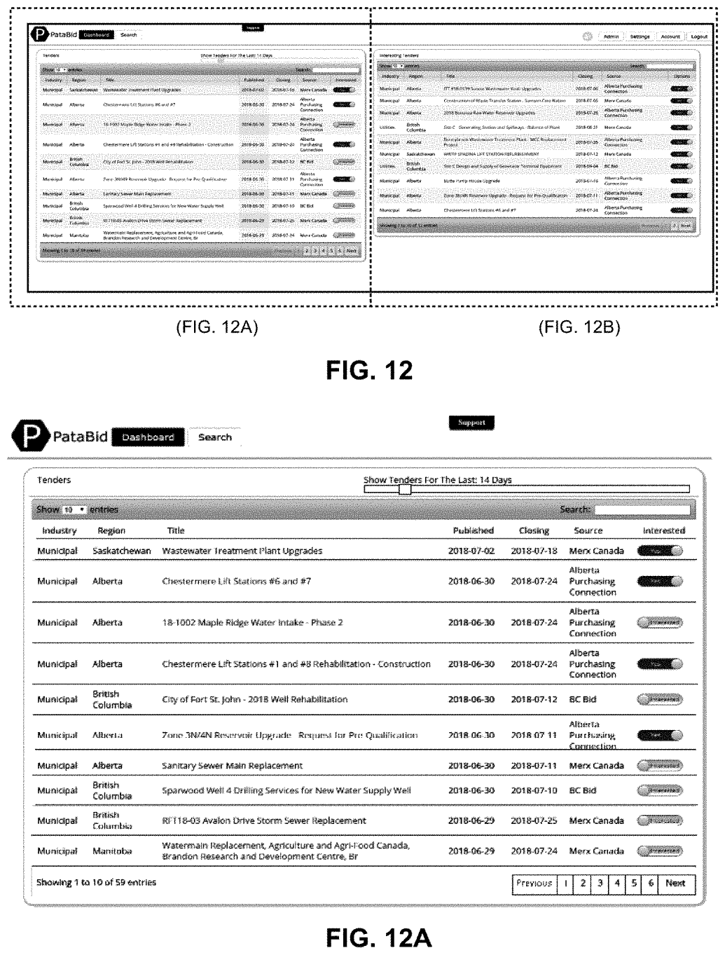

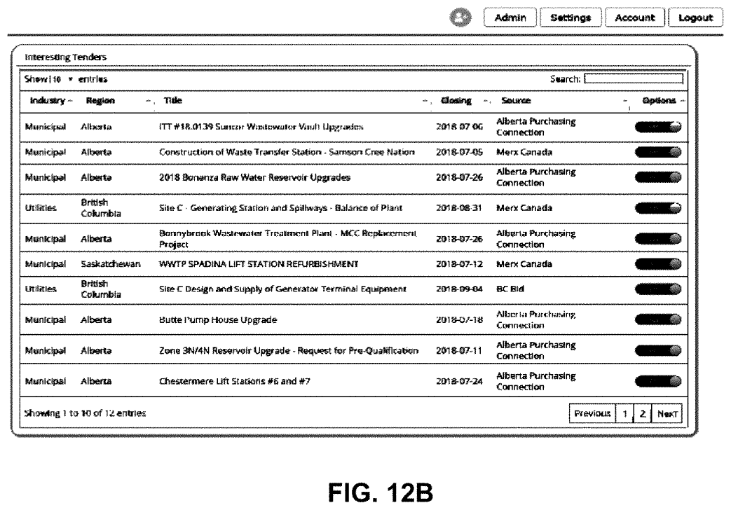

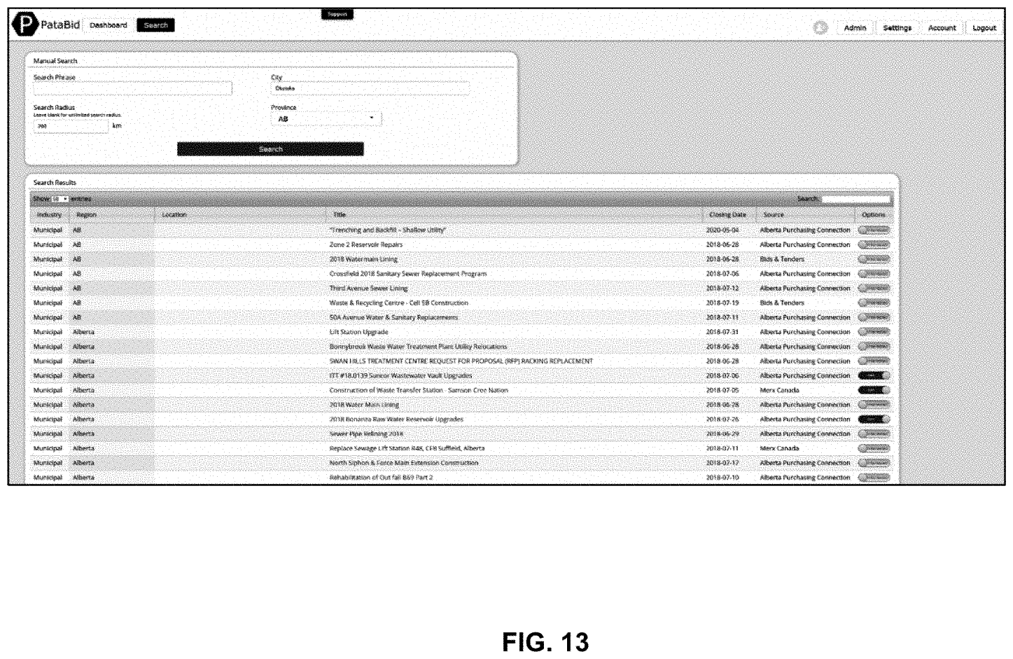

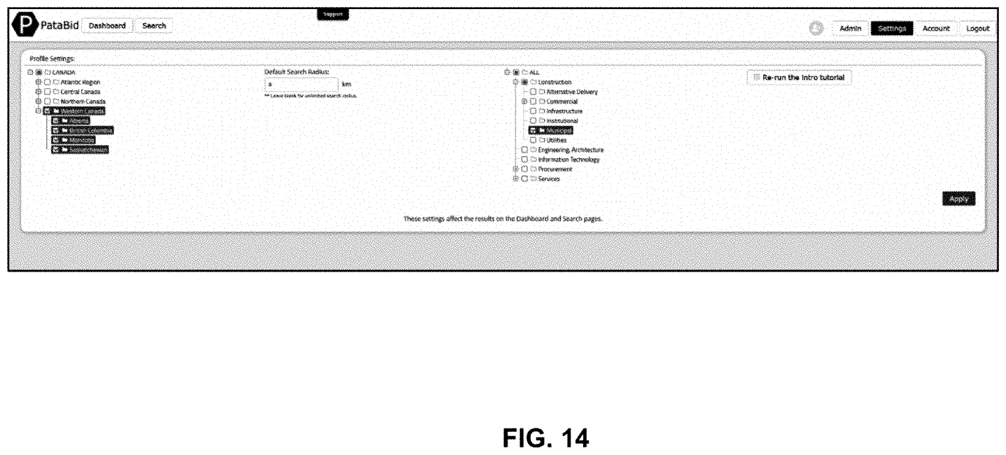

FIGS. 12 to 14 are screenshots of the information sent from client interface module 212 and displayed on the client computing-device 108. FIG. 12 is a screenshot showing a dashboard view with latest relevant data with FIGS. 12A and 12B showing enlarged portions of the dashboard view shown in FIG. 12. FIG. 13 is a screenshot showing general text-based and radius-based search page options. FIG. 14 is a screenshot showing a profile-settings page that allows selection of relevant categories and locations.

Those skilled in the art will appreciate that the use of AI such as neural networks for categorizing all incoming information provides a flexible and customizable solution and allows clients to filter out results that do not match their interests. The training dataset may be easily adjusted to add new categories and retrain the neural networks with the newly added categories for identifying the exact information that the user needs.

In above embodiments, the classification server computer 102 comprises a web scrapper or web crawler 202 for “crawling” through a plurality of external servers 106 such as a plurality of external web servers to collect tender information published thereon. In some alternative embodiments, the classification system 100 may comprise a scrapper or information collector for collecting other types of data such as emails for analysis and classification.

In above embodiments, the classification system 100 is used for searching, analyzing and classifying tender information. In some alternative embodiments, the classification system 100 may be used for searching, analyzing and classifying other information. For example, in one embodiment, the classification system 100 may be used as an automated shipping brokerage system for searching, analyzing and classifying truck shipping load postings. In this embodiment, the classification system 100 may comprise an information collector for collecting or “scraping” emails and other postings with shipping requests.

The classification system 100 in this embodiment has a similar structure as that in above embodiments, and executes a process for searching, analyzing and classifying truck shipping load postings as follows:

1. The information collector scans or scrapes emails and other postings for load information. Data related to truck shipping load is then extracted.

2. After data extraction, the system then collects the geospatial data for each truck shipping by utilizing a suitable map function such as the Google maps API.

3. The AI then categorizes the truckload data into structured truck/trailer combinations.

4. The structured truckload data is then presented to truck operators via a suitable means such as a smartphone/tablet application thereby allowing the truck operators to easily accept or reject a load suggestion.

Although embodiments have been described above with reference to the accompanying drawings, those of skill in the art will appreciate that variations and modifications may be made without departing from the scope thereof as defined by the appended claims.

What is claimed is:

1. A computerized data-classification system comprising:
a memory;
one or more processing structures coupled to the memory and comprising:
a data collection module for collecting raw data from a plurality of data sources;
a data extraction module for extracting unclassified data from the raw data;
a data classification module comprising a neural network architecture for classifying unclassified data into classified data; and
an interface for, in response to a query from a user, retrieving classified data based on a profile of the user, and sending the retrieved data to the user;
wherein the neural network architecture comprises:
a pre-trained word-representation layer comprising a pre-trained library; and
N one-dimensional convolutional (Conv1D) layers and (N−1) one-dimensional max-pooling (MaxPool1D) layers coupled in serial with each MaxPool1D layer intermediate two neighboring Conv1D layers, where N>1 is a positive integer.

2. The system of claim 1, wherein N is 2 or 3.

3. The system of claim 1, wherein said data classified data comprises a plurality of data categories; and wherein said data classification module is configured for:
encoding the unclassified data into a numerical representation for the neural network architecture to process;
processing the encoded data by the neural network architecture, the neural network architecture mathematically categorizing the encoded data and outputting a numeric output; and
decoding the numeric output into a categorical format.

4. The system of claim 3, wherein said encoding the unclassified data comprises:
using a tokenizer to numerically encode the unclassified data by using a mapping between text words and corresponding numerical values.

5. The system of claim 3, wherein the neural network architecture further comprises:
a one-dimensional global max pooling (GlobalMax1D) layer after a last one of the Conv1D layers; and
a network layer after the GlobalMax1D layer, said network layer comprising a plurality of neurons;
wherein a total number of the plurality of neurons equals to a total number of the data categories.

6. The system of claim 5, wherein said network layer is configured for using a softmax activation function to generate the numeric output of the neural network architecture.

7. The system of claim 1, wherein said one or more processing structures further comprise a trainer module for repeatedly called for continuously training the neural network architecture of the data classification module.

8. A method for assessing user performance, the method comprising:
collecting raw data from a plurality of data sources;
extracting unclassified data from the raw data;
classifying unclassified data into classified data by using a neural network architecture; and
in response to a query from a user, retrieving classified data based on a profile of the user, and sending the retrieved data to the user;
wherein the neural network architecture comprises:
a pre-trained word-representation layer comprising a pre-trained library; and
N one-dimensional convolutional (Conv1D) layers and (N−1) one-dimensional max-pooling (MaxPool1D) layers coupled in serial with each MaxPool1D layer intermediate two neighboring Conv1D layers, where N>1 is a positive integer.

9. The method of claim 8, wherein N is 2 or 3.

10. The method of claim 8, wherein said data classified data comprises a plurality of data categories; and the method further comprising:
encoding the unclassified data into a numerical representation for the neural network architecture to process;
processing the encoded data by the neural network architecture, the neural network architecture mathematically categorizing the encoded data and outputting a numeric output; and
decoding the numeric output into a categorical format.

11. The method of claim 10, wherein said encoding the unclassified data comprises:
using a tokenizer to numerically encode the unclassified data by using a mapping between text words and corresponding numerical values.

12. The method of claim 10, wherein the neural network architecture further comprises:
a one-dimensional global max pooling (GlobalMax1D) layer after a last one of the Conv1D layers; and
a network layer after the GlobalMax1D layer, said network layer comprising a plurality of neurons;
wherein a total number of the plurality of neurons equals to a total number of the data categories.

13. The method of claim 12, wherein said network layer is configured for using a softmax activation function to generate the numeric output of the neural network architecture.

14. The method of claim 8 further comprising:
repeatedly training the neural network architecture of the data classification module.

15. A computer-readable storage device comprising computer-executable instructions for assessing user performance, wherein the instructions, when executed, cause a processing structure to perform actions comprising:
collecting raw data from a plurality of data sources;
extracting unclassified data from the raw data;
classifying unclassified data into classified data by using a neural network architecture; and
in response to a query from a user, retrieving classified data based on a profile of the user, and sending the retrieved data to the user;
wherein the neural network architecture comprises:
a pre-trained word-representation layer comprising a pre-trained library; and
N one-dimensional convolutional (Conv1D) layers and (N−1) one-dimensional max-pooling (MaxPool1D) layers coupled in serial with each MaxPool1D layer intermediate two neighboring Conv1D layers, where N>1 is a positive integer.

16. The computer-readable storage device of claim 15, wherein N is 2 or 3.

17. The computer-readable storage device of claim 15, wherein said data classified data comprises a plurality of data categories; and wherein the instructions, when executed, cause a processing structure to perform further actions comprising:
encoding the unclassified data into a numerical representation for the neural network architecture to process;
processing the encoded data by the neural network architecture, the neural network architecture mathematically categorizing the encoded data and outputting a numeric output; and
decoding the numeric output into a categorical format.

18. The computer-readable storage device of claim 17, wherein said encoding the unclassified data comprises:
using a tokenizer to numerically encode the unclassified data by using a mapping between text words and corresponding numerical values.

19. The computer-readable storage device of claim 17, wherein the neural network architecture further comprises:
a one-dimensional global max pooling (GlobalMax1D) layer after a last one of the Conv1D layers; and
a network layer after the GlobalMax1D layer, said network layer comprising a plurality of neurons;
wherein a total number of the plurality of neurons equals to a total number of the data categories.

20. The computer-readable storage device of claim 19, wherein said network layer is configured for using a softmax activation function to generate the numeric output of the neural network architecture.
